(19) United States
(12) Patent Application Publication
(10) Pub. No.: US 2003/0150708 A1
(43) Pub. Date: Aug. 14, 2003

(54) Air treatment apparatus

(76) Inventor: Ronald G. Fink, Jupiter, FL (US)

Correspondence Address: MALIN HALEY AND DIMAGGIO, PA, 1936 S ANDREWS AVENUE, FORT LAUDERDALE, FL, 33316, US

(21) Appl. No.: 10/335,777

(22) Filed: Jan. 2, 2003

Related U.S. Application Data
(63) Continuation of application No. 09/614,648, filed on Jul. 12, 2000, now abandoned.

(51) Int. Cl. B01J 19/08; B01J 19/12

(52) U.S. Cl. 204/157.3; 422/4; 422/186

(57) ABSTRACT

An air treatment apparatus includes an air mover for directing air toward a target compound. The target compound includes at least one of copper, titanium dioxide, and silver. A UV source is adapted to direct light against the target compound. The light preferably has a wavelength of about 185 nm. Light striking the air will generate ozone and the striking the target compound will generate at least one of hydroxyl ions and super-oxide ions. A method for treating air is also disclosed.

### CROSS-REFERENCE TO RELATED APPLICATIONS

THIS APPLICATION IS A CONTINUATION, OF application Ser. No. 09/614,648 FILED ON JUL. 12, 2000.

### FIELD OF THE INVENTION

This invention relates generally to air treatment apparatus, and more particularly to air treatment apparatus for the removal of contaminants such as pollutants, organisms, and odors from air.

### BACKGROUND OF THE INVENTION

Airborne pollutants, organisms, and odors are a major source of concern in indoor atmospheres. Inorganic pollutants such as dust are commonly removed by filtration. Organic pollutants and organisms are more difficult to remove by filtration, and other methods for removing these contaminants have been used. Various chemicals and other bactericidal agents have been used to combat organisms, while various deodorants are supplied to the ambient air to control odors. These chemicals and bactericidal agents, however, must be replaced regularly and do not always effectively eliminate pollutants and organisms. Deodorants do not remove odors, but rather only mask them with a stronger and more acceptable scent.

Ozone treatment has become a common method for freshening air and removing odors. The ozone can be generated by a variety of methods. A common method is to subject the oxygen in air to ultraviolet light at 185 nm. This wavelength of light, when it contacts oxygen, is known to cause a chemical reaction which generates ozone. The flow rate of oxygen, and the dimension and intensity of the light, are used to control the amount of ozone generation since intense amounts of ozone are undesirable for humans. Such systems do not, however, effectively remove organic pollutants and organisms.

Hydroxyl radicals and super-oxide ions are known to oxidize volatile organic compounds (VOCs) that have been adsorbed on a catalyst surface. These radicals and ions will also kill and decompose adsorbed bioaerosols. This process is known as heterogeneous photocatalysis or photocatalytic oxidation (PCO). PCO is particularly desirable for treating VOCs because these materials are oxidized and are therefore eliminated rather than merely captured or removed from the airstream. This has the advantage that the PCO reactor does not readily contaminate such as is the case with filtration, where the filters must be regularly changed or cleaned. PCO reactors also usually have a low power consumption, long service life and low maintenance requirements.

### SUMMARY OF THE INVENTION

An air treatment apparatus according to the invention comprises an air mover for directing air toward a target compound. The target compound includes at least one selected from the group consisting of titanium dioxide, silver, and copper. The target compound preferably includes titanium dioxide. A UV light source is adapted to direct UV light against the target.

The target compound most preferably comprises between about 0-30% titanium dioxide, 0-30% silver, and 0-30% copper, by weight. The target compound can be provided as powder in a suitable binder or base material which holds the powder in place. In one embodiment, the base material comprises an epoxy, such as titanium-based white epoxy paint. Other methods of fixing the target compound in place, such as baking onto a metal substrate, electroplating, or adhering the target compound onto a substrate, are alternatively possible. It is further possible to paint the target compound as a pattern onto a translucent or transparent surface, such as a tube, which is then positioned around the bulb.

In a preferred embodiment, the UV light and target compound are provided in a housing. The housing has one or more ventilation openings for receiving ambient air, and a ventilation source such as a fan to draw air through the ventilation openings and direct the air past the UV light. UV light striking oxygen in the air will generate ozone. UV light striking the target compound will generate hydroxyl radicals and super-oxide ions. VOCs will contact hydroxyl ions and super-oxide ions that are formed by the UV light contacting the target compound. Filtration can be provided in the ventilation openings to remove inorganic particulate contaminants.

A method of treating air includes the step of directing the air at a target having at least one selected from the group consisting of titanium dioxide, copper and silver. The UV light preferably generates light at 185 nm so as to generate ozone on contact with oxygen in the air. Contact of the UV light with the target compound creates at least one of hydroxyl and super-oxide ions. The hydroxyl and super-oxide ions chemically react with VOCs and kill organisms to remove these contaminants from the air stream.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a perspective view of an air treatment apparatus according to the invention.

FIG. 2 is a schematic top plan view.

FIG. 3 is a cross-section taken along line 3-3 in FIG. 2.

### DETAILED DESCRIPTION OF THE PREFERRED EMBODIMENTS

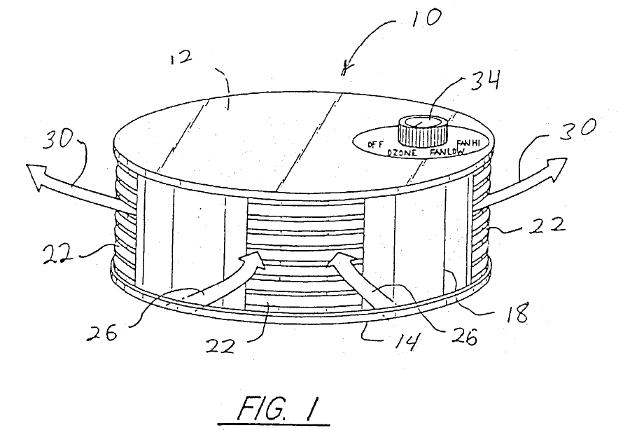

An air treatment apparatus 10 according to the invention is shown in FIG. 1. The air treatment apparatus can be conveniently provided in housing having a top lid portion 12, bottom portion 14, and side wall portion 18. In the embodiment shown, the housing is substantially cylindrical, although it will be appreciated that the housing could be provided in a variety of different shapes and sizes. Ventilation openings 22 are provided in the side wall 18 in order to permit the intake of air as shown by the arrows 26. Other ventilation openings 22 permit the exhaust of air as shown by arrows 30. A control knob 34 or other suitable switching device can be provided to permit the control of the apparatus. In the embodiment shown, the control knob 34 is adapted to switch the device between OFF-OZONE-FAN LOW-FAN HI positions.

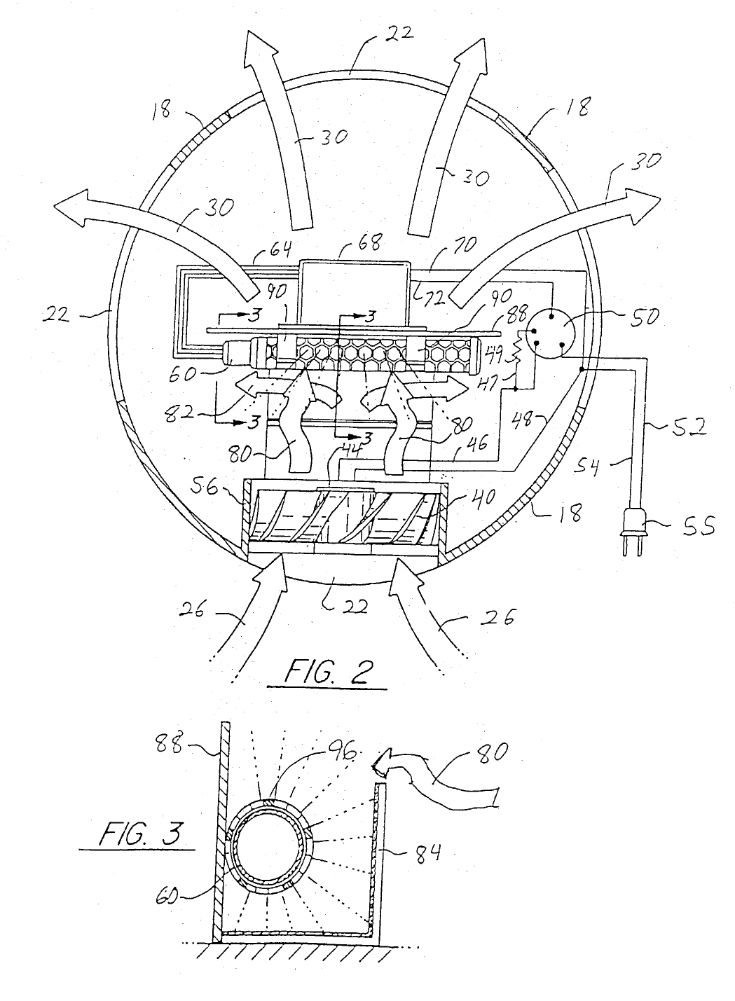

As shown in FIG. 2, air is drawn into the housing by the action of suitable structure such as a fan 40. The fan 40 can be driven by a fan motor 44 which receives power through lines 46, 48 which are connected to a switch assembly 50. A line 47 having resistor 49 is utilized to provide low power to the fan 40. The switch assembly 50 is operated by means of the control knob 34 to power various circuits including the fan 40. The switch assembly 50 receives power through lines 52, 54, and a standard electrical outlet plug 55. The fan 40 can be positioned in a suitable enclosure 56 formed in the housing.

A UV light source such as the UV lamp 60 is provided to generate UV light suitable to create ozone when the light strikes oxygen in the air. The UV light preferably generates light at about 185nm, which is a preferable wavelength for generating ozone. It is possible to have an additional UV source for a wavelength that is more effective to kill bacteria. Wavelengths of about 254 nm are currently preferred for killing bacteria. Wavelengths of light greater than about 385 nm are not currently preferred. The UV light which strikes the target compound generates hydroxyl (OH) and/or super-oxide ions such as Ti⁺⁺, Cu⁺⁺, and Ag⁺⁺.

The UV lamp 60 can be powered by suitable connections such as power supply lines 64 connecting to ballast 68. The ballast 68 can receive power through supply lines 70, 72 which connect to the switch assembly 50 and the power supply lines 52,54. Air leaving the fan 40 flows in the direction of arrows 80 to the vicinity of the lamp 60 such that oxygen in the air is contacted by the UV light and ozone is generated. A baffle 84 can be provided to limit the flow of air and contact between the air and UV light. This will limit the amount of ozone that is produced. Selection of an appropriate size and shape for the baffle 84 will be dependent on the volumetric flow rate of air from the fan 40, as well as the size and power of the lamp 60. The lamp 60 can be mounted by suitable structure such as supporting plate 88 and clamps 90. Air striking the lamp 60 will be directed to the sides as indicated by arrows 82 and will flow out of the housing in the direction of arrows 30.

The target compound can be positioned in the vicinity of the UV lamp 60 by many different methods and constructions. In one embodiment, the target compound is fixed to a substrate and the substrate is secured in position in the vicinity of the UV lamp and air flow such that contaminants in the air will strike the target compound and be contacted by the hydroxyl ions and/or super-oxide ions which are generated by the UV light striking the target compound.

The target compound is preferably provided in close proximity to the lamp 60, and in a form that permits light to escape the lamp 60. A target structure with one or more openings to permit the passage of at least a portion at least a portion of the incident light is preferably provided. A perforated tube is one possible embodiment and, in the embodiment shown in FIG. 2, a mesh 96 is provided. The mesh 96 wraps around the lamp 60 such that light from the light 60 will contact the mesh 96. The target compound is provided on the mesh 96, such that light leaving the lamp 60 will in part flow substantially unimpeded through the opening of the mesh to contact the air and generate ozone, while some of the light will strike the mesh and target compound and will generate at least one of hydroxyl and super-oxide ions. The mesh size, and size of openings will depend on the relative amount of ozone which is desired as compared to the relative amount of hydroxyl ions that are desired. The more UV light that escapes the target structure, the more ozone will be generated by the light. Smaller openings in the target structure will provide more target surface area for the generation of hydroxyl ions and super-oxide ions. The relative dimensions will in part depend on the size and intensity of the lamp and the volumetric air flow, as well as the particular target compound that is utilized.

The target compound is preferably at least one of titanium dioxide, copper, and silver. Titanium dioxide is currently preferred. Alloys and mixtures are also possible. Any method for securing the target compounds in proximity to the UV light source and airflow is suitable, however, these materials are preferably coated or otherwise adhered onto a substrate. The mesh 96 is one such substrate. Plastics such as fluoropolymers of the Dupont Company of Wilmington, Del. can be suitable substrates. The substrate can be provided as a clear plastic tube that is positioned around the bulb, and the target compound can be painted or otherwise provided in a pattern on the tube, so that some of the light will strike the target compound and some of the light will pass through the tube to generate ozone. The manner in which the target compound is secured to the substrate can be varied. In one embodiment, the target compound is provided as a powder and this powder is combined in a suitable base or binder to secure the powder to a substrate such as the mesh 96. One such binder is an epoxy, such as the Imron epoxy based paint by the Dupont Company of Wilmington, Del. Other bases and binders would also be suitable, however, such bases should not degrade readily upon exposure to UV light and should adhere the target compound in such a way as to permit the UV light to strike the target compound. It is alternatively possible to make the target structure out of the target compound, such as a mesh of copper, silver, titanium dioxide, or alloys thereof. It is also possible to paint, adhere or electroplate the target compound to the substrate.

The UV light source must be capable of generating sufficient UV light at a wavelength or wavelengths which will create ozone. The dimensions and intensity of the light can be selected to control the concentration of ozone in the air leaving the treatment apparatus. It is presently preferred that, at a point measured 6 inches from the housing, the concentration of ozone in the air be no more than about 0.04 ppm. A presently preferred bulb is approximately 118 mm long and 15 mm diagonal, 1.6 inches across, 28 volts, 420 mA, 8 watts and generates UV at a wavelength of 185 nm. Although larger bulbs are readily available, it has been found that such bulbs frequently generate higher levels of ozone than is presently preferred.

Experiments were performed to verify that the unit creates adequate quantities of ozone and hydroxyl ions.

Test 1

The purpose of this test was to measure the level of ozone production obtained when using an ultraviolet light source in the presence of titanium dioxide. By comparing this level to that of ozone levels produced in the absence of TiO₂, a determination was made as to the relative catalytic effect the TiO₂ has on the production of the OH— radical.

Materials and Methods:

A 42″ long 3″ diameter clear PVC chamber was constructed to perform the experiment. End caps placed on the chamber were fitted with 1″ hubble fittings to allow a 40″ long 1″ diameter quartz tube to be placed in the center of the chamber. A 36″ HO UV/03 bulb was placed in the quartz tube. A ¼″ inlet and outlet were tapped at opposite ends of the chamber to allow feed gas to enter, travel past the UV light source then exit to be measured. Two 36″ long pieces of expanded metal were constructed to form two 2½″ wide by 36″ long aluminum matrixes. One was left untreated and was used as the control. The other was coated with titanium dioxide powder. The non-treated matrix was sealed into the chamber and tested. A bottled oxygen feed gas was fed through the chamber then exited it where it was split into two streams. One stream was 10 liters/minute and was bubbled into a 200 gallon tank; the other was 0.5 liters/minute and was fed into a Anseros Ozone Monitor. After 10 minutes of flow the readings were taken. Then the matrix was removed and replaced with the TiO₂ matrix. The experiment was repeated and readings taken.

Data:

| | Matrix | Gas Flow | Monitor | Start | End Time | Reading |
|---|---|---|---|---|---|---|
| Test | Media | 1/m | Flow 1/m | Time | (reading) | g O₂/m3 |
| A | No TiO₂ | 10 | .5 | 1203 | 1213 | 2.8 |
| A | TiO₂ | 10 | .5 | 1346 | 1356 | 1.9 |
| B | No TiO₂ | 5 | .5 | 0853 | 0903 | 1.4 |
| B | TiO₂ | 5 | .5 | 0910 | 0920 | .8 |

Results:

The test results indicate that the presence of TiO₂ in the test chamber reduced overall ozone production. Test A shows a reduction of ozone production in the presence of TiO₂ of 31.2%. Test B shows a reduction of ozone production in the presence of TiO₂ of 42.9%.

TEST 2

The purpose of this test was to determine if ozone and ultraviolet light in the presence of titanium dioxide would produce hydroxyl radicals. Formaldehyde gas is not affected by ozone or ultraviolet light, it is however destructed by hydroxyl radicals. Comparing the level of formaldehyde gas as it exits the test chamber permits a determination if in fact the OH— radicals are formed.

Materials and Methods:

A 42″ long 3″ diameter clear PVC chamber was constructed to perform the experiment. End caps placed on the chamber were fitted with 1″ hubble fittings to allow a 40″ long 1″ diameter quartz tube to be placed in the center of the chamber. A 36″ HO UV/03 bulb was placed in the quartz tube. A ¼″ inlet and outlet were tapped at opposite ends of the chamber to allow feed gas to enter, travel past the UV light source then exit to be measured. One 36″ long piece of expanded metal was constructed to form a 2½″ wide by 36″ long Aluminum matrix. This matrix was coated with titanium dioxide powder. The carrier gas that was used was bottled oxygen. Just before the oxygen entered the chamber it was passed through a venturi. This venturi was connected to a flow meter and then to a 500 ml flask. This flask contained formalin soaked cotton balls (as the formalin evaporated, formaldehyde gas was formed). During testing the formaldehyde gas was transferred by the vacuum created at the venturi and mixed with the oxygen feed line at 0.01 liters/minute. Formaldehyde readings were taken using a Drager tube (67 33 081) for formaldehyde detection, as well as being detectable by the obvious formaldehyde odor. The test was started by applying the oxygen to the chamber (simultaneously inducing the formaldehyde gas as well). After a five minute period (allowing the flow through the chamber to stabilize) a base reading was taken. The UV/03 bulb was then turned on, and a second sample was then taken five minutes later. Any reduction between the initial reading and the second reading would indicate OH— production.

Data:

| | | Gas | | | Reading | Reading |
|---|---|---|---|---|---|---|
| | Matrix | Flow | Start | End Time | (Drager) | (subjective- |
| Test | Media | l/m | Time | (reading) | Formaldehyde | olfactory) |
| A | TiO₂ | 10 | 1300 | 1305 | 2.2 ppm | Heavy |
| A | TiO₂ | 10 | 1312 | 1317 | N/A | Very low |
| | | | | | (interference) | |
| B | TiO₂ | 10 | 0853 | 0858 | 2.1 ppm | Heavy |
| B | TiO₂ | 10 | 0910 | 0915 | N/A | Very low |
| | | | | | (interference) | |
| C | TiO₂ | 5 | 1002 | 1007 | .8 ppm | Heavy |
| C | TiO₂ | 5 | 1015 | 1020 | N/A | None |
| | | | | | (interference) | Detected |

Results:

The test results indicate that the presence of TiO₂ with ozone and ultra violet light will reduce the amount of formaldehyde found exiting the chamber. One can conclude then that the interaction of these three components does in fact produce hydroxyl radicals, which in turn causes the reduction of the formaldehyde. The ozone gas generated in the process caused interference with the Drager tubes on the second part of the test. Due to this the only method used to determine the reduction of formaldehyde was subjective (using odor alone). Although subjective, the differences observed clearly indicate the overall effectiveness of this process.

This invention can be embodied in other forms without departing from the spirit or essential attributes thereof, and accordingly, reference should be had to the following claims, rather than to the foregoing specification, as indicating the scope of the invention.

I claim:

1. An air treatment apparatus, comprising:
an air mover for directing air toward a target compound, said target compound comprising at least one selected from the group consisting of titanium dioxide, copper, and silver; and
a UV light source adapted to direct UV light toward said air and said target, whereby said UV light striking said air will generate ozone and striking said target compound will generate at least one selected from the group consisting of hydroxyl ions and super-oxide ions.

2. The air treatment apparatus of claim 1, wherein said target compound comprises titanium dioxide.

3. The air treatment apparatus of claim 1, wherein said target compound comprises 0-30% titanium dioxide, 0-30% silver, and 0-30% copper, by weight.

4. The air treatment apparatus of claim 1, wherein said target compound comprises a base.

5. The air treatment apparatus of claim 4, wherein said base comprises an epoxy base.

6. The air treatment apparatus of claim 5, wherein said copper, silver and titanium dioxide is provided as powder.

7. The air treatment apparatus of claim 1, wherein said UV light and said target compound are provided in a housing.

8. The air treatment apparatus of claim 1, wherein said UV light generates ultraviolet light at a wavelength of 185 nm.

9. The air treatment apparatus of claim 1, wherein said target compound is provided on a target structure, said target structure being positioned substantially adjacent to said UV light and adapted to permit the passage of a portion of said UV light to contact said air.

10. The air treatment apparatus of claim 9, wherein said target structure comprises a plurality of light-penetrable portions so as to permit the passage of UV light.

11. The target element of claim 10, wherein said target structure is a mesh.

12. The air treatment apparatus of claim 1, further comprising at least one baffle to restrict the flow of air toward said UV light.

13. A method for treating air, comprising the steps of:
directing said air toward a target comprising at least one selected from the group consisting of copper, silver and titanium dioxide;
directing UV light toward said target, said UV light being at a wavelength sufficient to generate ozone from oxygen in said air and being sufficient to generate at least one selected from the group consisting of hydroxyl ions and super-oxide ions.

14. The method of claim 13, wherein said UV light and said target are provided in a housing, and said air is drawn into said housing, said target being provided within said housing and directing air from said target out of said housing.

15. The method of claim 13, wherein said target comprises 0-30% titanium dioxide, 0-30% silver, and 0-30% copper.

16. The method of claim 13, wherein said target compound is provided as a powder, said powder being adhered to a substrate.

17. The method of claim 13, further comprising the step of filtering said air prior to directing said air at said target.

18. The method of claim 13, wherein said UV light has a wavelength of about 185nm.

19. The method of claim 13, wherein said target compound is provided on a target structure, said target structure being positioned substantially adjacent to said UV light and being adapted to permit the passage of a portion of said UV light to permit said UV light to contact said air and generate ozone.
